(19) United States
(12) Patent Application Publication
(10) Pub. No.: US 2026/0193135 A1
(43) Pub. Date: Jul. 9, 2026

(54) Vegetal Concrete Masonry Unit and Method and System for Manufacture Thereof

(71) Applicant: Greenjams Buildtech Private Limited, Visakhapatnam, (IN)

(72) Inventor: Tarun JAMI, Visakhapatnam (IN)

(21) Appl. No.: 19/436,430

(22) Filed: Dec. 30, 2025

Related U.S. Application Data
(63) Continuation-in-part of application No. 17/793,579, filed on Jan. 21, 2021, now Pat. No. 12,534,403.

(30) Foreign Application Priority Data
Jan. 21, 2020 (IN) 202041002654

(51) Int. Cl. C04B 28/00; C04B 18/24; C04B 20/02; C04B 22/00; C04B 40/00; C04B 103/10; C04B 111/00

(52) U.S. Cl. CPC C04B 28/006; C04B 18/248; C04B 20/023; C04B 22/00; C04B 40/0046; C04B 40/0071; C04B 2103/10; C04B 2111/00017; C04B 2111/00224

(57) ABSTRACT

A vegetal concrete masonry unit and method and system for manufacturing thereof are disclosed. The masonry unit comprises treated crop residues (e.g., paddy straw, wheat straw, bagasse), a binder of hydrated lime, ground granulated blast furnace slag (GGBFS), and low-content alkali activator (2.5-20% by mass), and aggregates in a mass ratio of 1:0.1:1.5 to 1:5:5, achieving compressive strengths of 2-20 MPa and densities of 950-1900 kg/m³. The method involves alkali-treating residues at 0.1-10M NaOH for 15-1500 minutes, passing through a screw press, mixing with binder and aggregates to form C-A-S-H and N-A-S-H gels, and high-pressure molding (2-10 MPa). The system includes silos, a retention tank/screw press, pan mixer, and hydraulic press. This sustainable bio-composite utilizes agricultural/industrial wastes, reduces emissions by 80%, is energy efficient, enhances compatibility and mechanical performance, and provides thermal insulation for eco-friendly building blocks and panels.

### CROSS REFERENCE TO RELATED APPLICATIONS

This application is a Continuation-in-Part Application of U.S. patent application Ser. No. 17/793,579 filed on Jul. 18, 2022, which is a 371 U.S. National Phase of International Application No. PCT/IN2021/050055, filed on Jan. 21, 2021, and claims priority to Indian Patent Application number 202041002654, filed on Jan. 21, 2020. The entire disclosures of the above applications are expressly incorporated by reference herein. This Continuation-in-Part application includes improvements and additional embodiments not disclosed in the parent application, such as broader treatment methods for crop residues (e.g., using retention tanks and screw presses), expanded material combinations (e.g., additional aggregates and crop residues), and optimized ratios for enhanced properties, which may have an effective filing date of the present application.

### FIELD OF THE INVENTION

The present invention relates to a product and process for the preparation of a building material. In particular, the present invention relates to environmentally sustainable, eco-friendly green concrete building blocks made of bio-composite materials comprising geopolymers, lime, agricultural and industrial waste. More particularly, the present invention relates to a method and system for manufacturing a vegetal concrete masonry unit.

### BACKGROUND OF THE INVENTION

Rapid industrialization and urbanization has spurred construction at an alarming rate, boosting the demand for construction materials. Typically, cement-based concretes containing coarse and fine aggregates (usually comprised of stone, sand and water) are the materials most abundantly used in building construction. Continuous production of such aggregates has led to serious depletion of natural resources and is an emerging problem in recent times. In addition, conventional building materials account for high production costs, high greenhouse gas emissions, and generate a high demand of energy and water resources, all of which have a significantly negative environmental impact. For example, production of conventional building materials contributes to increased emissions of noxious pollutants, acceleration of climate change and depletion of topsoil through mining. Concurrently, on the other hand, the amassing of unmanageable quantities of industrial and agricultural solid waste, particularly in developing countries, has intensified environmental concerns relating to their disposal. For example, routine burning of unwanted agricultural crop residue is a global phenomenon and an important contributor to abject air quality worldwide. Lack of effective and environmentally sustainable management of industrial and agricultural residues and waste is a mounting risk for the environment and causes air, surface water and ground water pollution.

The drawbacks of conventional concrete materials, the need for conservation of natural resources, the availability of limited landfill spaces, the high energy demands, unmanageable industrial and agricultural solid waste, and the desire of nations to reduce green-house gas emissions have spurred the demand for alternative high quality concrete products. The gradual depletion of raw materials has fostered increased demand for recycled building materials which can replace traditional building products. Hence, recycling of wastes into sustainable, environmentally friendly construction materials could be a feasible and potentially cost-effective solution to not only combat waste pollution problem by keeping them out of the waste stream, but also as an economical alternative to the design of green sustainable concrete buildings.

In recent years, the application of green building materials has become popular in many countries. Green buildings made from materials using agricultural waste or industrial waste offer numerous environmental, technical and economic benefits such as increased strength and durability, improved workability, superior resistance to acid attack and fire, minimum requirement of energy, improved thermal behavior, cost-effectiveness, 80% fewer carbon dioxide emission than normal concrete, thereby reducing environment pollution, and can also contribute to improved indoor and outdoor air quality and a healthy and more productive indoor environment.

The prior art documents on agricultural waste building materials include hydraulic lime, calcic lime and other commercial lime-based binders, and also include geopolymer as binders, which is an alkali-activated mineral material produced through polycondensation of inorganic compounds at ambient or slightly elevated temperatures. An example of such a reaction includes aluminosilicate with an alkaline activator such as concentrated alkali hydroxide, silicate, carbonate, or sulfate. The most promising feature of the geopolymer is its formulation using waste materials such as fly ash/pulverized fuel ashes (collectively PFA), and ground granulated blast furnace slag (GGBFS) as resource materials. The application of vegetal matter such as fibers in concrete improves tensile strength, ductility and post-fracture behavior of composite concretes. Hence, vegetal geopolymer concretes could be provided as an additional layer to an existing structural wall for providing reinforcement of the structural frame and for insulating purpose.

However, previous prior art processes either include vegetal matter only in very small quantities (about 1% by mass) or suffer from problems such as structurally weak material with low compressive strength and non-uniform mechanical performance. Large amounts of activators in traditional geopolymer based vegetal concretes also negate the environmental benefits offered and make them unviable alternatives. Also, traditional fly ash based geopolymers are produced using high temperature curing which makes their manufacture expensive and unviable. Furthermore, prior art processes clearly show that addition of vegetal matter to geopolymers resulted in weakened composites because of incompatibility. Therefore, there is also a need to improve the compatibility between vegetal matter and the geopolymer matrix. There is a constant need to provide a novel, environmentally sustainable, and viable process for the preparation of a vegetal concrete masonry unit with better structural or load-bearing function, good thermal insulation and higher compressive strength.

Recent developments (post-2021) have explored agro-wastes like almond shell ash, corn cob ash, and other biomass ashes in geopolymer concretes for enhanced sustainability and strength, but these often require high activator levels, elevated curing temperatures, limiting their viability for masonry units with high compressive strength (e.g., >5 MPa) and low density (e.g., 950-1260 kg/m³). The present invention addresses these gaps by providing a novel, environmentally sustainable, and viable process for preparing a vegetal concrete masonry unit with improved structural load-bearing function, good thermal insulation, higher compressive strength, and reduced activator content.

### OBJECTS OF THE INVENTION

One of the primary objects of the present invention is to provide a novel, environmentally sustainable and viable process for the preparation of a vegetal concrete masonry unit with performance related advantages over existing products.

Another object of the present invention relates to a novel vegetal concrete masonry unit comprising crop residues and an alkali activated mineral binder comprised of lime and industrial co-products from steel and power plants.

Another object of the present invention relates to improvements in the mechanical performance of vegetal concrete masonry unit made using the crop residues and an alkali activated mineral binder comprised of lime and industrial co-products from steel and power plants.

Another object of the present invention is to increase the structural durability and structural integrity of the vegetal concrete masonry unit.

Another object of the present invention is to provide a vegetal concrete masonry unit with good thermal insulation.

Another object of the present invention is to provide a vegetal concrete masonry unit with increased load-bearing function and a higher compressive strength.

Another object of the present invention is to utilize agricultural waste to manufacture a vegetal concrete masonry unit with the intention to recycle and resolve the agricultural waste pollution problem.

Another object of the present invention is to use the following as raw materials for the preparation of a vegetal concrete masonry unit: (a) Crop residues: paddy straw, wheat straw, bagasse, cotton stalk, corn stover, sugar cane trash, sunflower stalk, soy stalk, chia stalk, kenaf stalk, hemp stalk, mustard stalk, saw dust, jute stalk, elephant grass, miscanthus or any other agricultural fiber, individually and/or in combination thereof. (b) Binder: ground granulated blast furnace slag, activator and hydrated lime and/or a combination thereof. (c) Other raw materials: fly ash/pulverised fuel ash (collectively referred to as PFA), soil, sand, stone crushing residue, manufactured sand, stone chips, construction and demolition waste, crushed concrete, crushed bricks, anhydrous sodium silicate, sodium hydroxide, water and/or a combination thereof. The PFA, soil, sand, stone crushing residue, manufactured sand, stone chips, construction and demolition waste, crushed concrete and bricks are collectively referred to as aggregates and each may be used individually or in combination. Additional equivalents, such as other alkali activators (e.g., potassium hydroxide) or pozzolanic materials, may be substituted to achieve similar results.

Yet another object of the present invention is to reduce the amount of alkali activator used in the manufacture of the vegetal concrete masonry unit to make it a viable alternative to conventional masonry units.

A further object of the present invention is to lower the activator content, making geopolymers and other geopolymer based vegetal concretes viable for use.

Another object of the present invention is to lower the activator content, making geopolymer based vegetal concretes environmentally sustainable.

These and other objects of the present invention will become readily apparent upon further review of the following description. The objects are exemplary and not limiting.

### SUMMARY OF THE INVENTION

One aspect of the present invention relates to a vegetal concrete masonry unit which comprises of treated crop residues, binder and aggregates in a mass ratio ranging from 1:0.1:1.5 to 1:5:5, wherein the unit exhibits a compressive strength of at least 2 MPa, preferably 5-20 MPa, and dry densities of about 950 to 1900 kg/m³ as demonstrated in the examples.

Another aspect of the present invention relates to a method for the preparation of a vegetal concrete masonry unit, the method comprising: either cooking the crop residue in a cooker or treating the crop residue in a retention tank with sodium hydroxide (NaOH) or equivalent alkali and water; mixing hydrated lime, Ground Granulated Blast Furnace Slag (GGBFS), and sodium silicate activator in a ribbon blender to constitute the binder; intermixing the treated crop residue, binder and aggregates together in a pan mixer with water to form an alkali activated homogeneous paste/gel; and molding the homogenous paste/gel obtained in the intermixing step using a high-pressure hydraulic press to form the vegetal concrete masonry unit.

Yet another aspect of the present invention relates to a system for the manufacture of a vegetal concrete masonry unit, the system comprising: a lime silo containing hydrated lime; an activator powder and GGBFS mixed in a ribbon blender to form a binder; a binder silo for storing the binder; a retention tank and screw press for treating raw crop residue and a treated crop residue hopper for receiving and storing the mixture from the screw press; a hopper for storing the aggregates, a pan mixer for obtaining the wet mix; wherein the treated crop residues from the hopper, binder from the binder silo and aggregates from the hopper are mixed with water in a pan mixer; wherein the wet mix from the pan mixer is cast into molds and compacted into blocks using a hydraulic block machine with a high compacting pressure, and then transported to the stock yard.

The crop residues are treated in a retention tank with 0.1M to 10M NaOH and water for a duration of 15 to 1500 minutes.

The method also includes a binder containing sodium silicate activator in an amount equal to 2.5-20% of the total mass wherein the rest includes GGBFS or a mix of hydrated lime of at least 85 percent calcium hydroxide mixed with GGBFS in a 1:10 to 2:3 ratio.

The binder is further mixed with aggregates, treated crop residues, and water in a pan mixer and cast into molds using a high-pressure hydraulic press with a compacting pressure of up to 10 MPa.

The alkali activated homogeneous paste/gel of the method is Calcium-Alumino-Silicate-Hydrate (C-A-S-H/CASH) paste/gel, wherein the aggregates react with GGBFS in the presence of an activator powder to form Sodium-Alumino-Silicate-Hydrate (N-A-S-H/NASH) geopolymers, as well as CASH gel. The activator powder is anhydrous sodium silicate powder or equivalents.

The treating of the crop residue is carried out in a cooker being a stainless-steel container constructed with a pressure lock system configured to withstand a total internal pressure of minimum 2 atm or a retention tank and screw press.

The binder comprises, Ground Granulated Blast Furnace Slag individually or in combination with hydrated lime, and sodium silicate activator.

The retention tank may be constructed out of steel, brick, cement, concrete, or any other metal or non-metallic item suitable for building said container.

The screw press is preferably constructed using a spring-loaded or pneumatically controlled end/pressure plate capable of applying a pressure of 5 to 50 bar on the crop residues being passed by the screw.

### BRIEF DESCRIPTION OF THE ACCOMPANYING DRAWINGS

FIG. 1 illustrates a system for manufacturing a vegetal concrete masonry unit according to the present invention.

FIG. 2 illustrates a process showing the steps of manufacturing a vegetal concrete masonry unit according to the present invention.

### DETAILED DESCRIPTION

A novel, environmentally sustainable vegetal concrete masonry unit/brick and viable process and system for the preparation of the same with performance related advantages over existing products is disclosed. The vegetal concrete masonry unit/brick of the present invention finds application in civil constructions in the form of blocks and pre-cast wall panels. This vegetal concrete masonry unit may be cast in a hybrid composite construction, where there is the core made of this material, encased in a steel frame. These hybrid panels will then be erected on site to make a pre-engineered building.

Thus, the present invention relates to an economically sustainable vegetal concrete masonry unit and the method for manufacturing the same, wherein the vegetal concrete masonry unit comprises Ground Granulated Blast Furnace Slag with or without hydrated lime, aggregates, treated crop residues and sodium silicate used in defined amounts. Further, the process for the manufacture of vegetal concrete masonry unit employs a step of treating the crop residue with alkali such as sodium hydroxide, which increases the homogeneity of the material mixture and eliminates the set-retarding extracts from the crop residues; and upon further addition of binder materials, improves the compressive strength of the formed vegetal concrete masonry unit.

In the present invention, lime and Ground Granulated Blast Furnace Slag (GGBFS) act as the main binding agent. The addition of sodium silicate activates the reaction between lime and GGBFS to form Calcium-Alumino-Silicate-Hydrate (C-A-S-H/CASH) gel that creates the matrix to hold the vegetal matter and aggregates in the concrete. Formation of CASH gel is a desirable hydration product that occurs when building limes or Portland cements are mixed with water. The aggregates react with GGBFS in the presence of the activator to form Sodium-Alumino-Silicate-Hydrate (N-A-S-H/NASH) geopolymers, as well as CASH gel. For the reaction between GGBFS and aggregates, the presence of lime (calcium hydroxide) also creates a suitable pH environment to facilitate the reaction. A part of the remaining calcium hydroxide in the mixture mineralizes the treated crop residues, and the other part subsequently turns into calcium carbonate through carbonation. The crop residue is selected from a group of crop residues comprising paddy straw, wheat straw, bagasse, cotton stalk, corn stover, sugar cane trash, sunflower stalk, soy stalk, chia stalk, kenaf stalk, hemp stalk, mustard stalk, saw dust, jute stalk, elephant grass, miscanthus and/or a combination thereof. Therefore, changes in activator, lime, GGBFS and aggregates content would result in varying amounts of CASH and NASH, thereby affecting the strength of the final vegetal concrete product. For example, the resulting units can achieve compressive strengths ranging from 2 MPa to 20 MPa or higher, depending on the ratios and conditions, as supported by the examples herein. One skilled in the art can adjust parameters within these ranges without undue experimentation to achieve desired compatibility and strength.

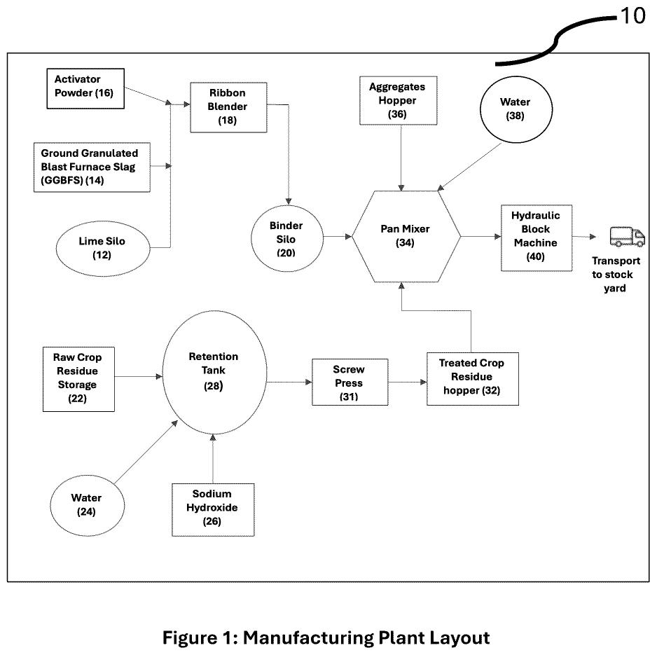

FIG. 1 discloses a system 10 for manufacturing of a vegetal masonry unit according to the present invention, wherein the system comprises a lime silo 12 containing GGBFS or a mixture of hydrated lime and GGBFS 14 and an activator powder 16 in a ribbon blender 18 to form a binder which is stored in a binder silo 20, a raw crop residue from the storage 22 is mixed with water 24 and sodium hydroxide 26 in a stainless steel cooker/retention tank 28, the mixture obtained from the retention tank 28 is passed through a screw press 31 and subsequently to the treated crop residue hopper 32. The treated crop residues from hopper 32, binder from the binder silo 20 and aggregates hopper 36 are mixed with water 38 in a pan mixer 34, wherein, the wet mix of the pan mixer 34 is compacted and cast into molds using hydraulic block machine 40 with a high compacting pressure, and then transported to the stock yard.

The crop residues are treated in a retention tank with 0.1M to 10M sodium hydroxide (NaOH) and water for a duration of 15-1500 minutes, preferably 75 minutes; wherein the binding materials-include GGBFS or a mix of GGBFS with hydrated lime of at least 85 percent calcium hydroxide in a 2:3 ratio, and sodium silicate activator in an amount equal to 2.5-20% of the total mass of GGBFS/hydrated lime and GGBFS in a ribbon blender to constitute the binder; wherein the binder is further mixed with aggregates, treated crop residue, and water in a pan mixer and cast into molds using a high-pressure hydraulic press with a compacting pressure of up to 10 MPa. In embodiments, the treatment enhances compatibility by removing set-retarding extracts, allowing for lower activator content (2.5-20%) compared to prior art, uses less energy, add recycled construction materials in the aggregates, thus making the process more environmentally sustainable and cost-effective.

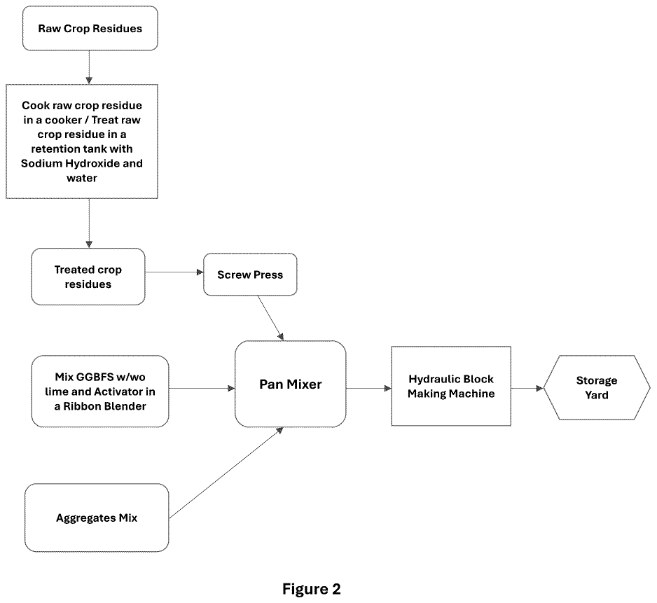

FIG. 2 illustrates a process that shows the steps of manufacturing of vegetal concrete masonry unit according to the present invention, which are as follows:

### 1. Processing of Crop Residues

Each kilogram of crop residues, either individually or as a combination of paddy straw, wheat straw, bagasse, cotton stalk, corn stover, sugar cane trash, sunflower stalk, soy stalk, chia stalk, kenaf stalk, hemp stalk, saw dust, mustard stalk, jute stalk, elephant grass, miscanthus or any other agricultural fiber are added to 1-5 liters of 0.1M to 10M NaOH solution in a retention tank constructed with steel, brick, concrete or any other metal or non-metallic material, or equivalents. The crop residues are left to soak in the retention tank for a duration of 15 to 1500 minutes, after which, the crop residues are removed from the retention tank and passed through a screw press and de-watered to a saturated, semi-saturated or unsaturated condition.

### 2. Preparation of Binder

Ground Granulated Blast Furnace Slag (GGBFS) is used individually or mixed with hydrated lime consisting of at least 85% calcium hydroxide in a ratio of 10:1 to 3:2, respectively. Anhydrous sodium silicate powder in an amount equal to 2.5% to 20% of the GGBFS or mixture of GGBFS and hydrated lime is added. The constituents are blended together for a duration of at least 5 minutes.

### 3. Preparation of Vegetal Concrete Mix

The processed crop residues in the wet form, the binder, aggregates and water are added to a pan mixer in quantities as set out in table 1. The constituents are mixed for at least a duration of 3 minutes.

TABLE 1
Vegetal concrete, comprehensive

| | Quantity | Compressive | Dry Density |
|---|---|---|---|
| Raw Material | (kg/m³) | Strength (MPa) | (kg/m³) |
| Pre-mixed binder | 150-400 | 5-20 MPa | 950-1900 |
| Treat crop residues in water | 30-900 | | |
| saturated condition | | | |
| Fly Ash | 400-1400 | | |
| Water | 60-120 | | |

### 4. Production of Vegetal Masonry Unit

The wet mix is transferred to a hydraulic block making machine consisting of a metal die, metal press and hydraulic jack capable of delivering a compression force of 2 MPa to 10 MPa.

In order to more clearly describe the nature of the present invention, specific examples will hereinafter be described. It should be understood, however, that this is done solely by way of example, and is intended neither to delineate the scope of the invention nor limit the ambit of the appended claims. These examples are non-limiting embodiments.

### SPECIFIC EXAMPLES

### Example 1 (Paddy Straw)

### Step 1: Processing of Crop Residues

Each kilogram of paddy straw is added to 1.5 litres of 0.5M NaOH solution, mixed and soaked in the solution in the retention container for a duration of 60 minutes, after which the paddy straw along with the NaOH solution is removed from the container and passed through a screw press with the pressure plate applying a pressure of 8 bar. The resulting paddy straw collected from the screw press is in a semi-saturated condition.

### Step 2: Preparation of Binder

Ground Granulated Blast Furnace Slag (GGBFS) is mixed with hydrated lime consisting of at least 85% calcium hydroxide in a ratio of 7:1, respectively. Anhydrous sodium silicate powder in an amount equal to 8% of the mixture of GGBFS and hydrated lime is added. The constituents are blended together for a duration of at least 5 minutes.

### Step 3: Preparation of Vegetal Concrete Mix

The treated crop residues in the semi-saturated form, the binder, aggregates and water are added to a pan mixer in quantities as set out in table 2. The constituents are mixed for a duration of 3 minutes.

### Step 4: Production of Vegetal Concrete Masonry Unit

The wet mix is transferred to a hydraulic block making machine consisting of a metal die, metal press and hydraulic jack capable of delivering a compression force of at least 2 MPa.

TABLE 2
Paddy straw based vegetal concrete, Example 1

| | Quantity | Compressive | Dry Density |
|---|---|---|---|
| Raw Material | (kg/m³) | Strength (MPa) | (kg/m³) |
| Pre-mixed binder | 300 | 10 MPa | 1590 |
| Treated paddy straw | 300 | | |
| Aggregates | 900 | | |
| Water | 90 | | |

### Example 2 (Paddy Straw)

### Step 1: Processing of Crop Residues

Each kilogram of paddy straw is added to 1.5 litres of 0.1M NaOH solution, mixed and soaked in the solution in the retention container for a duration of 240 minutes, after which the paddy straw is removed from the container and passed through a screw press with the pressure plate applying a pressure of 8 bar. The resulting paddy straw collected from the screw press is in a semi-saturated condition.

### Step 2: Preparation of Binder

Ground Granulated Blast Furnace Slag (GGBFS) is used individually. Anhydrous sodium silicate powder in an amount equal to 20% of the GGBFS is added. The constituents are blended together for a duration of at least 5 minutes.

### Step 3: Preparation of Vegetal Concrete Mix

The processed crop residues in the semi-saturated form, the binder, aggregates and water are added to a pan mixer in quantities as set out in table 3. The constituents are mixed for a duration of 3 minutes.

### Step 4: Production of Vegetal Concrete Masonry Unit

The wet mix is transferred to a hydraulic block making machine consisting of a metal die, metal press and hydraulic jack capable of delivering a compression force of at least 2 MPa.

TABLE 3
Paddy straw based vegetal concrete, Example 2

| | Quantity | Compressive | Dry Density |
|---|---|---|---|
| Raw Material | (kg/m³) | Strength (MPa) | (kg/m³) |
| Pre-mixed binder | 170 | 7.5 MPa | 1411 |
| Treated paddy | 510 | | |
| straw | | | |
| Aggregates | 680 | | |
| Water | 51 | | |

Please note: In the above two examples, preparation of crop residues can happen with NaOH solution having molar concentration between 0.1M to 10M. The treating time and treating pressure will vary depending on the concentration of the solution.

### Example 3 (Saw Dust)

### Step 1: Processing of Crop Residues

Each kilogram of saw dust is added to 1.5 litres of 5M NaOH, mixed and soaked in the solution in the retention container for a duration of 30 minutes, after which the saw dust is removed from the container and passed through a screw press with the pressure plate applying a pressure of 8 bar. The resulting saw dust collected from the screw press is in a semi-saturated condition.

### Step 2: Preparation of Binder

Ground Granulated Blast Furnace Slag (GGBFS) is mixed with hydrated lime consisting of at least 85% calcium hydroxide in a ratio of 3:2, respectively. Anhydrous sodium silicate powder in an amount equal to 5% of the mixture of GGBFS and hydrated lime is added. The constituents are blended together for a duration of at least 5 minutes.

### Step 3: Preparation of Vegetal Concrete Mix

The processed saw dust in the wet form, the binder, aggregates and water are added to a pan mixer in quantities as set out in table 4. The constituents are mixed for a duration of 3 minutes.

### Step 4: Production of Vegetal Concrete Masonry Unit

The wet mix is transferred to a hydraulic block making machine consisting of a metal die, metal press and hydraulic jack capable of delivering a compression force of at least 2 MPa.

TABLE 4
Saw dust based vegetal concrete, Example 3

| | Quantity | Compressive | Dry Density |
|---|---|---|---|
| Raw Material | (kg/m³) | Strength (MPa) | (kg/m³) |
| Pre-mixed binder | 340 | 7.5 MPa | 1836 |
| Treated saw dust | 34 | | |
| aggregates | 1360 | | |
| Water | 102 | | |

### Example 4 (Wheat Straw)

### Step 1: Processing of Crop Residues

Each kilogram of wheat straw is added to 1.5 litres of 10M NaOH solution, mixed and soaked in the solution in the retention container for a duration of 15 minutes, after which the paddy straw is removed from the container and passed through a screw press with the pressure plate applying a pressure of 3 bar. The resulting paddy straw collected from the screw press is in a saturated condition.

### Step 2: Preparation of Binder

Ground Granulated Blast Furnace Slag (GGBFS) is mixed with hydrated lime consisting of at least 85% calcium hydroxide in a ratio of 2:1, respectively. Anhydrous sodium silicate powder in an amount equal to 10% of the mixture of GGBFS and hydrated lime is added. The constituents are blended together for a duration of at least 5 minutes.

### Step 3: Preparation of Vegetal Concrete Mix

The processed crop residues in the wet form, the binder, aggregates and water are added to a pan mixer in quantities as set out in table 5. The constituents are mixed for a duration of 3 minutes.

### Step 4: Production of Vegetal Concrete Masonry Unit

The wet mix is transferred to a hydraulic block making machine consisting of a metal die, metal press and hydraulic jack capable of delivering a compression force of at least 5 MPa.

TABLE 5
Wheat straw based vegetal concrete, Example 4

| | Quantity | Compressive | Dry Density |
|---|---|---|---|
| Raw Material | (kg/m³) | Strength (MPa) | (kg/m³) |
| Pre-mixed binder | 190 | 7 MPa | 1767 |
| Treat wheat straw | 760 | | |
| Aggregates | 760 | | |
| Water | 57 | | |

### Example 5 (Bagasse)

### Step 1: Processing of Crop Residues

Each kilogram of bagasse is added to 1.5 litres of 10M NaOH, mixed and soaked in the solution in the retention container for a duration of 25 minutes, after which the bagasse is removed from the container and passed through a screw press with the pressure plate applying a pressure of 10 bar. The resulting bagasse collected from the screw press is in a semi-saturated condition.

### Step 2: Preparation of Binder

Ground Granulated Blast Furnace Slag (GGBFS) is used individually. Anhydrous sodium silicate powder in an amount equal to 15% of the GGBFS is added. The constituents are blended together for a duration of at least 5 minutes.

### Step 3: Preparation of Vegetal Concrete Mix

The processed crop residues in the wet form, the binder, aggregates and water are added to a pan mixer in quantities as set out in table 6. The constituents are mixed for a duration of 3 minutes.

### Step 4: Production of Vegetal Concrete Masonry Unit

The wet mix is transferred to a hydraulic block making machine consisting of a metal die, metal press and hydraulic jack capable of delivering a compression force of at least 7.5 MPa.

TABLE 6
Bagasse based vegetal concrete, Example 5

| | Quantity | Compressive | Dry Density |
|---|---|---|---|
| Raw Material | (kg/m³) | Strength (MPa) | (kg/m³) |
| Pre-mixed binder | 280 | 10 MPa | 1764 |
| Treated bagasse | 420 | | |
| Aggregates | 980 | | |
| Water | 80 | | |

### Example 6 (Bagasse)

### Step 1: Processing of Crop Residues

Each kilogram of bagasse is added to 1.5 litres of 1M NaOH, mixed and soaked in the solution in the retention container for a duration of 60 minutes, after which the bagasse is removed from the container and passed through a screw press with the pressure plate applying a pressure of 8 bar. The resulting bagasse collected from the screw press is in a semi-saturated condition.

### Step 2: Preparation of Binder

Ground Granulated Blast Furnace Slag (GGBFS) is mixed with hydrated lime consisting of at least 85% calcium hydroxide in a ratio of 10:1, respectively. Anhydrous sodium silicate powder in an amount equal to 10% of the GGBFS or mixture of GGBFS and hydrated lime is added. The constituents are blended together for a duration of at least 5 minutes.

### Step 3: Preparation of Vegetal Concrete Mix

The processed crop residues in the wet form, the binder, aggregates and water are added to a pan mixer in quantities as set out in table 6. The constituents are mixed for a duration of 3 minutes.

### Step 4: Production of Vegetal Concrete Masonry Unit

The wet mix is transferred to a hydraulic block making machine consisting of a metal die, metal press and hydraulic jack capable of delivering a compression force of at least 2 MPa.

TABLE 7
Bagasse based vegetal concrete, Example 6

| | Quantity | Compressive | Dry Density |
|---|---|---|---|
| Raw Material | (kg/m³) | Strength (MPa) | (kg/m³) |
| Pre-mixed binder | 350 | 20 MPa | 1855 |
| Treated bagasse | 700 | | |
| Aggregates | 700 | | |
| Water | 100 | | |

### Example 7 (Miscanthus)

### Step 1: Processing of Crop Residues

Each kilogram of miscanthus is added to 1.5 litres of 5M NaOH, mixed and soaked in the solution in the retention container for a duration of 30 minutes, after which the miscanthus is removed from the container and passed through a screw press with the pressure plate applying a pressure of 8 bar. The resulting miscanthus collected from the screw press is in a semi-saturated condition.

### Step 2: Preparation of Binder

Ground Granulated Blast Furnace Slag (GGBFS) is mixed with hydrated lime consisting of at least 85% calcium hydroxide in a ratio of 10:1, respectively. Anhydrous sodium silicate powder in an amount equal to 10% of the GGBFS or mixture of GGBFS and hydrated lime is added. The constituents are blended together for a duration of at least 5 minutes.

### Step 3: Preparation of Vegetal Concrete Mix

The processed crop residues in the wet form, the binder, aggregates and water are added to a pan mixer in quantities as set out in table 6. The constituents are mixed for a duration of 3 minutes.

### Step 4: Production of Vegetal Concrete Masonry Unit

The wet mix is transferred to a hydraulic block making machine consisting of a metal die, metal press and hydraulic jack capable of delivering a compression force of at least 2 MPa.

TABLE 8
Miscanthus based vegetal concrete, Example 7

| | Quantity | Compressive | Dry Density |
|---|---|---|---|
| Raw Material | (kg/m³) | Strength (MPa) | (kg/m³) |
| Pre-mixed binder | 350 | 20 MPa | 1855 |
| Treated bagasse | 700 | | |
| Aggregates | 700 | | |
| Water | 100 | | |

What is claimed is:

1. A method for the preparation of a vegetal concrete masonry unit, the method comprising:
treating crop residue in a retention tank with an alkali and water and passing the treated crop through a screw press to yield a treated crop residue;
mixing Ground Granulated Blast Furnace Slag (GGBFS), individually or in combination with hydrated lime, with an activator powder for at least 5 minutes in a ribbon blender to constitute a binder;
intermixing the treated crop residue, the binder and aggregates together in a pan mixer with water to form an alkali activated homogeneous paste/gel; and
molding the homogenous paste/gel obtained in the intermixing step using a high-pressure hydraulic press capable of delivering a pressure of at least 2 MPa to form the vegetal concrete masonry unit;
wherein the crop residue is treated with 0.1 M to 10M aqueous NaOH or equivalent alkali solution for a duration of 15 to 1500 minutes to improve compatibility between the crop residue and the binder;
wherein the hydrated lime in the binder is at least 85 percent calcium hydroxide and is mixed with GGBFS in a 1:10 to 2:3 ratio; and
wherein the sodium silicate activator powder is in an amount equal to 2.5-20% of the total mass of the GGBFS or the hydrated lime and the GGBFS in the ribbon blender to constitute the binder.

2. The method as claimed in claim 1, wherein the homogenous paste/gel is cast into molds using the high-pressure hydraulic press with a compacting pressure of up to 10 MPa.

3. The method as claimed in claim 1, wherein the homogeneous paste/gel is Calcium-Alumino-Silicate-Hydrate (C-A-S-H/CASH) paste/gel.

4. The method as claimed in claim 1, wherein the aggregates include one or more of pulverized fuel ash, soil, sand, stone crushing residue, manufactured sand, stone chips, construction and demolition waste, crushed concrete, crushed bricks.

5. The method of claim 1, wherein the binder is formed by one of the group consisting of:
(a) mixing GGBFS with a sodium silicate activator powder in a ribbon blender for at least 5 minutes, the sodium silicate activator powder being present in an amount of 2.5-20% of the total mass of the GGBFS; and
(b) mixing hydrated lime of at least 85% calcium hydroxide mixed with GGBFS in a 1:10 to 2:3 ratio, and then mixing the resulting mixture with a sodium silicate activator powder in a ribbon blender for at least 5 minutes, the sodium silicate activator powder being present in an amount of 2.5-20% of the total mass of the GGBFS and hydrated lime.

6. The method as claimed in claim 1, wherein the intermixing includes reacting the aggregates and GGBFS with the activator powder to form Sodium-Alumino-Silicate-Hydrate (N-A-S-H/NASH) geopolymers, as well as CASH paste/gel.

7. The method as claimed in claim 6, wherein the activator powder is anhydrous sodium silicate powder.

8. The method as claimed in claim 1, wherein the retention tank is a container constructed out of steel, brick, cement, concrete, or any other metal or non-metallic material suitable for building said container.

9. The method as claimed in claim 1, wherein the treated crop residue is passed through a screw press; and
wherein the screw press is preferably constructed using a spring-loaded or pneumatically controlled end/pressure plate capable of applying a pressure of 5 to 50 bar on the crop residue being passed by the screw.

10. The method as claimed in claim 1, wherein the intermixing is conducted for a duration of 3 minutes.

11. The method as claimed in claim 1, wherein the molding is carried out through a hydraulic block making machine including a metal die, metal press and hydraulic jack configured to deliver a compression pressure of 2 MPa to 10 MPa.

12. The method as claimed in claim 1, wherein the crop residue is selected from the group consisting of paddy straw, wheat straw, bagasse, cotton stalk, corn stover, sugar cane trash, sunflower stalk, soy stalk, chia stalk, kenaf stalk, hemp stalk, mustard stalk, saw dust, jute stalk, elephant grass, miscanthus, and combinations thereof.

13. The method as claimed in claim 1, wherein the alkali is selected from the group consisting of sodium hydroxide (NaOH), potassium hydroxide (KOH).
